(19) United States
(12) Patent Application Publication
(10) Pub. No.: US 2010/0080696 A1
(43) Pub. Date: Apr. 1, 2010

(54) BLOWER HOUSING AND METHOD OF MANUFACTURE

(76) Inventor: Russell W. Hoeffken, Millstadt, IL (US)

Correspondence Address: Patent Docket Department;Armstrong Teasdale LLP, One Metropolitan Square, Suite 2600, St. Louis, MO, 63102-2740, US

(21) Appl. No.: 12/630,919

(22) Filed: Dec. 4, 2009

Related U.S. Application Data
(63) Continuation-in-part of application No. 11/266,078, filed on Nov. 2, 2005, now Pat. No. 7,632,067.
(60) Provisional application No. 60/627,805, filed on Nov. 15, 2004.

(51) Int. Cl. F04D 29/42; B23P 11/00

(52) U.S. Cl. 415/203; 29/428

(57) ABSTRACT

Blower housings and methods of manufacture include protrusions and openings in edges thereof providing an interlocking assembly. Reduced manufacturing steps and greater versatility to join different materials and materials of different thickness are provided, without requiring welds and fasteners common to conventional blower housing assemblies.

### CROSS REFERENCE TO RELATED APPLICATIONS

This application is a continuation in part application of U.S. application Ser. No. 11/266,078 filed Nov. 2, 2005 which claims the benefit of U.S. Provisional Patent Application No. 60/627,805 filed Nov. 15, 2004, the disclosures of which are each hereby incorporated by reference in their entirety.

### BACKGROUND OF THE INVENTION

The field of the invention relates generally to blower housings for blower fan assemblies used in HVAC systems, although the present invention can also be utilized in other industries employing blower systems.

Blower housings of the type pertaining to the present invention are typically employed in forced air heating furnaces or air conditioners. In most cases, the blower is assembled in the interior of the HVAC equipment. Ambient air is blown by the blower over heat exchangers that heat or cool the air. The heated or cooled air is then forced from the furnace/air conditioner by the blower. A typical blower housing contains a cylindrical blower fan and is constructed from a pair of housing side walls spaced at opposite lateral sides of the blower housing and a wrapper wall sheet that is connected around peripheral edges of the two side walls. The wrapper wall sheet spaces the two side walls laterally from each other and gives the blower housing a general cylindrical configuration well suited for containing the cylindrical blower fan.

In commercially manufactured blower housings, the side walls and the wrapper wall sheet of a conventional non-welded blower housing assembly are typically either attached by a crimped folded over seam joint or, as in the case of applicant's prior U.S. Pat. No. 5,221,183, a two-sectional angled seam joint. Both of these attachment types use seams which are known to function as an essential slip joint allowing movement and/or separation of the assembly's side walls and wrapper wall sheet. This movement and/or separation problem is particularly apparent during final assembly of the complete blower unit (i.e. motor and blower fan installation). When separated, the side walls and the wrapper wall sheet are no longer usable thereby causing significant operating and yield loss (e.g. scrap) during the manufacturing or repair process. Conventional blower housings attempt to address the blower housing separation problem by utilizing either spot welds and/or auxiliary fasteners, such as end screws, neither of which is satisfactory since both increase the manufacturing cost of the blower housing.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a perspective view of an exemplary embodiment of a blower housing formed in accordance with an exemplary embodiment of the invention.

FIG. 2 is a detailed perspective view of a portion of the embodiment shown in FIG. 1 taken along line 2 of FIG. 1.

FIG. 3 is a detailed perspective view of a portion of the embodiment shown in FIG. 1 taken along line 3 of FIG. 1.

FIG. 4 is a detailed perspective view of a portion of the embodiment shown in FIG. 1 taken along line 4 of FIG. 1.

FIG. 5 is a perspective unassembled view of the embodiment shown in FIG. 1.

FIG. 5a is another perspective unassembled view of the embodiment shown in FIG. 1.

FIG. 6 is a top plan unassembled view of the embodiment shown in FIG. 1.

FIG. 7 is a left side unassembled view of the embodiment shown in FIG. 1.

FIG. 7a is a detailed side view of portion of FIG. 7 taken along line 7a and further illustrating the one or more first apertures of the wrapper wall sheet.

FIG. 7b is a detailed side view a portion of FIG. 7 taken along line 7b and further illustrating the one or more first protrusions of the first side wall.

FIG. 7c is a right side unassembled view of the embodiment shown in FIG. 1.

FIG. 7d is a detail right side view of a portion of FIG. 7c taken along line 7d and further illustrating the one or more second apertures of the wrapper wall sheet.

FIG. 7e is a detail right side view of a portion of FIG. 7c taken along line 7e and further illustrating the one or more second protrusions of the second side wall.

FIG. 8 is a cross sectional view of an unlocked seam prior to forming taken along line 8 of FIG. 5 and further illustrating the one or more first apertures and the first lateral edge of the wrapper wall sheet, and the one or more first protrusions of the first side wall.

FIG. 8a is another cross sectional view of an unlocked seam prior to forming taken along line 8a of FIG. 5a and further illustrating the one or more second apertures and the second lateral edge of the wrapper wall sheet, and the one or more second protrusions of the second side wall.

FIG. 9 is a top assembled view of the embodiment shown in FIG. 1.

FIG. 10 is a cross sectional view of a locked seam after forming taken along line 10 of FIG. 9.

FIG. 10a is another cross sectional view of the locked seam after forming taken along line 10a of FIG. 9.

FIG. 11 is a perspective view of another exemplary blower housing formed in accordance with an exemplary embodiment of the invention.

FIG. 12 is a detail perspective view of the embodiment shown in FIG. 11 taken along line 12.

FIG. 12a is a detail perspective view of the embodiment shown in FIG. 11 taken along line 12a.

FIG. 13 is a cross sectional view of a locked seam after forming and taken along line 13 of FIG. 12.

FIG. 13a is another cross sectional view of a locked seam after forming taken along line 13a of FIG. 12a.

FIG. 14 is a perspective assembly view of another blower housing assembly formed in accordance with an exemplary embodiment of the invention.

FIG. 15 is an end view of a portion of the blower housing shown in FIG. 14.

FIG. 16 is a perspective view of a wrapper wall sheet section for the assembly shown in FIG. 14.

FIG. 17 is an end view of the wrapper wall sheet section shown in FIG. 16.

FIG. 18 is a perspective view a blower housing side wall sheet section for the assembly shown in FIG. 14 prior to assembly.

FIG. 19 is an end view of the side wall sheet section shown in FIG. 18.

FIG. 20 illustrates a first end assembly view of the wrapper wall sheet and side wall sheet shown in FIGS. 16 and 18.

FIG. 21 is a second end assembly view of the wrapper wall sheet and side wall sheet shown in FIG. 20 and showing an unlocked seam.

FIG. 22 is a perspective assembly view of another embodiment of a blower housing assembly.

FIG. 23 illustrates a cross sectional view of a portion of the assembly shown in FIG. 22.

FIG. 24 illustrates another exemplary blower housing assembly in perspective view.

FIG. 25 illustrates a cross sectional view of the assembly shown in FIG. 24.

FIG. 26 is a perspective view a blower housing wrapper wall sheet section for the assembly shown in FIGS. 24 and 25 prior to assembly.

FIG. 27 is a perspective view of a blower housing side wall sheet section for the assembly shown in FIGS. 24 and 25.

FIG. 28 is perspective view of another embodiment of a blower housing assembly.

FIG. 29 is a cross sectional view of a locked seam in the assembly shown in FIG. 28.

FIG. 30 illustrates the assembly shown in FIG. 29 in an unlocked condition.

FIG. 31 illustrates a portion of the assembly shown in FIG. 30 in cross sectional view.

FIG. 32 illustrates a blower housing side wall sheet section for the assembly shown in FIG. 30.

FIG. 33 illustrates a blower housing wrapper wall sheet section for the assembly shown in FIG. 30.

FIG. 34 is an exemplary blower housing side wall sheet section showing a protrusion that is cut through on the top and bottom edges.

FIG. 35 is an exemplary blower housing side wall sheet section showing a protrusion that is cut partway through on the top and bottom edges.

FIG. 36 is blower housing side wall sheet section showing protrusions that are cut through on three sides while the facing sides remain uncut.

FIG. 37 is a blower housing side wall sheet section showing protrusions that are cut partway through on three sides while the facing sides remain uncut.

FIG. 38 is a blower housing side wall sheet section showing a protrusion that is cut through on one side while the other three sides remain uncut.

FIG. 39 is a blower housing side wall sheet section showing a protrusion that is cut partway through on one side while the other three sides remain uncut.

FIG. 40 illustrates a wrapper wall sheet section having a protrusion cut through on three sides while the facing sides remain uncut.

FIG. 41 illustrates a wrapper wall sheet section having protrusions that are cut partway through on three sides while the facing sides remain uncut.

FIG. 42 is a trimetric view of a blower housing wrapper section before being formed to the blower side and showing a protrusion that is cut on one side while the other three sides remain uncut.

FIG. 43 is a rotated view of the blower housing wrapper section shown in FIG. 43 before being formed to the blower side showing a protrusion that is cut on one side while the other three sides remain uncut.

FIG. 44 is a trimetric view of a blower housing wrapper section, excluding the blower side, after being formed to the blower side showing a protrusion that is cut on one side while the other three sides remain uncut.

FIG. 45 is an end view of the blower housing wrapper section shown in FIG. 44.

### DETAILED DESCRIPTION OF THE INVENTION

Inventive embodiments of blower housings are described hereinbelow that advantageously overcome problems in the art, including but not necessarily limited to those mentioned above. This is accomplished at least in part by virtue of versatile combination locking protrusions and openings forming seams, described in detail below that, among other things, capably allow for the joining of different materials and/or different material thicknesses of materials.

The versatility of the inventive concepts disclosed, which is readily adaptable to material variations, can provide significant engineering advantages such as thicker material utilization on the load bearing side wall (which typically supports the motor and wheel assembly) of a blower housing assembly, and thinner material utilization on the non-load bearing side wall and the wrapper wall sheet.

Also, a greater size range of blower housings can be manufactured in the same assembly machines with less cycle time and without changeover or modification to the equipment, thereby reducing the manufacturing cost of the blower housings. The ability to join the blower housing dissimilar material or material of varying thickness is desired since the assembly machine can be built easier and less expensively. Accordingly, one assembly or forming machine can be programmed to not only make a larger size range of blower housings but also to produce the blower housings faster and therefore less expensively.

The combination locking protrusions and openings forming the seam of the present invention further provides that the locking protrusions are substantially flush with the outside surface of the wrapper wall sheet when finally engaged in the opening regardless of orientation or material variation. This ensures a substantially smooth seam throughout its entire formed length.

The uniquely formed joint or seam including combination locking protrusions and openings additionally provides positive lockup of the blower housing side walls to a blower housing wrapper wall sheet, thereby essentially eliminating unintentional separation of the formed unit both prior to final manufacturing assembly and during its entire useful service life.

Slippage in the seams or joints between the side walls and wrapper wall of blower housing during assembly is also prohibited by the locked seams, which is especially useful during manufacturing processes involving worn or out of adjustment forming machines. The unique locking seams further allow for use of spring loaded forming rollers within the forming machine whereby a wide range of materials (including thicknesses) may be utilized.

More specifically, in contemplated embodiments the wrapper wall sheet may have a first lateral edge flange and a second lateral end flange opposite the first lateral edge flange. The lateral edge flanges may include inner portions and outer portions having one or more apertures. The side walls may have an inner surface, an outer surface, and a circumferential edge with an edge margin having one or more protrusions. The one or more protrusions may protrude from the surface of the side walls. The one or more apertures of the wrapper wall sheet are capable of receiving the one or more protrusions of the side walls. This provides wrapper wall sheet lateral edge flange attachment to the edge margins of the circumferential edges of the side walls by a formed joint or seam.

The formed joint or seam includes the combination of the one or more protrusions of the edge margin of the side walls received within the one or more apertures of the lateral edge flanges of the wrapper wall sheet. Thus, when the lateral edge flanges of the wrapper wall sheet are formed or pressed against the edge margins of the side walls, the one or more protrusions are substantially locked within the one or more apertures.

Exemplary blower housings may be manufactured from sheet metal, and more typically sheet metal which is either inherently corrosion resistant or coated to provide corrosion resistant properties. Typical sheet metals include but are not limited to stainless steel, aluminum, and coated steel products such as pre-painted steel, galvanized steel, Galvalume® steel materials, or other aluminized steels. In exemplary embodiments, the sheet metal would typically have a thickness range of 16-26 gauge, as conventionally measured within the sheet metal industry.

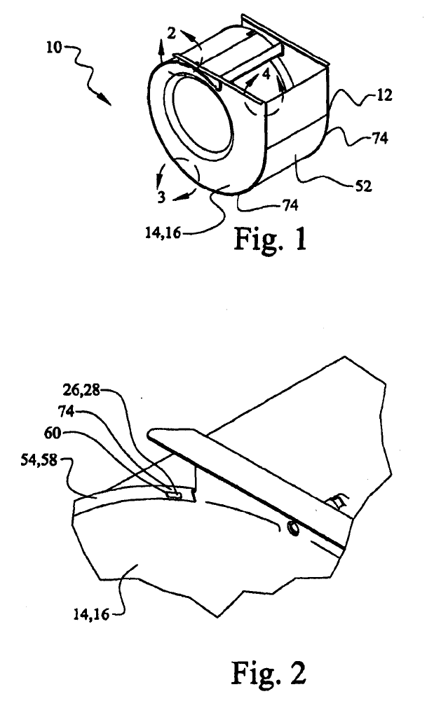

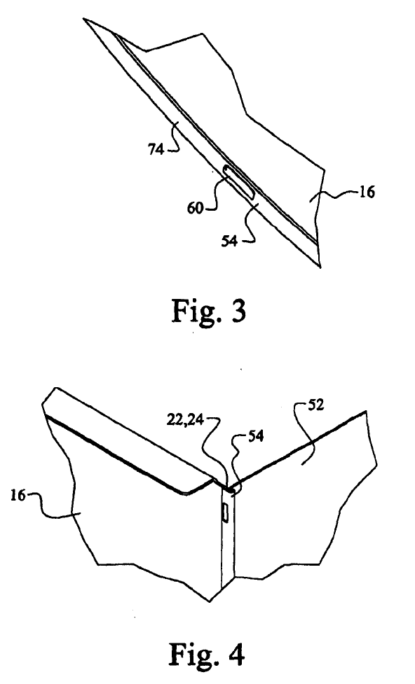

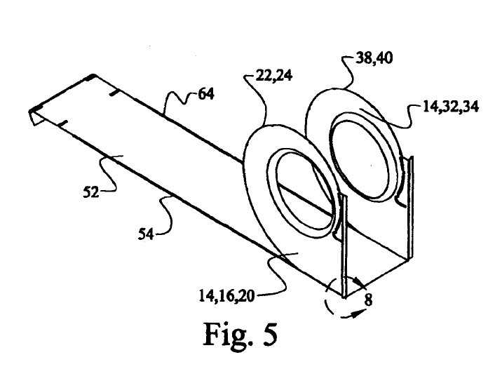

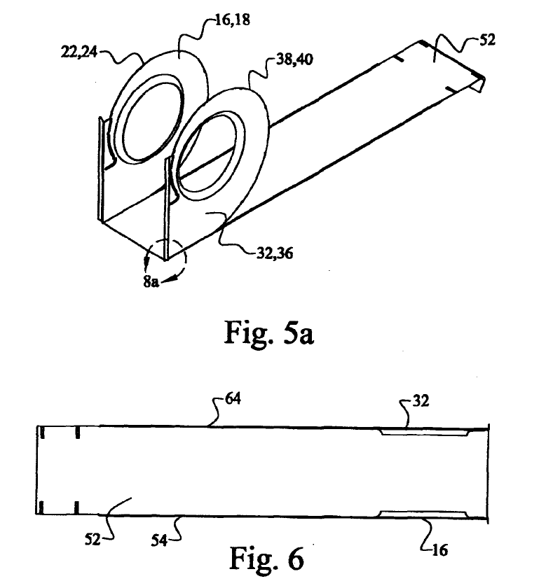

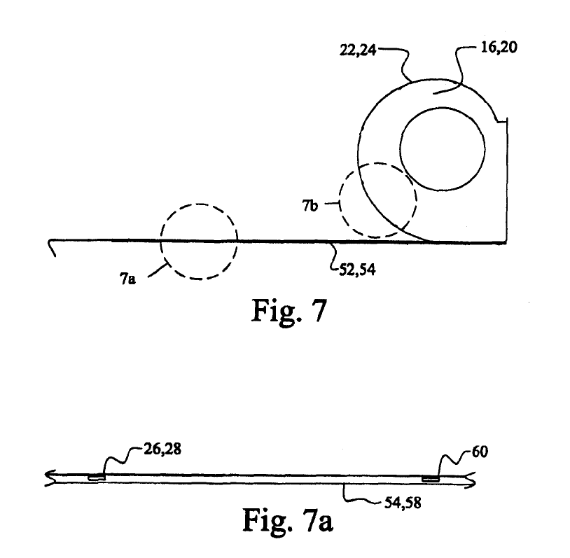

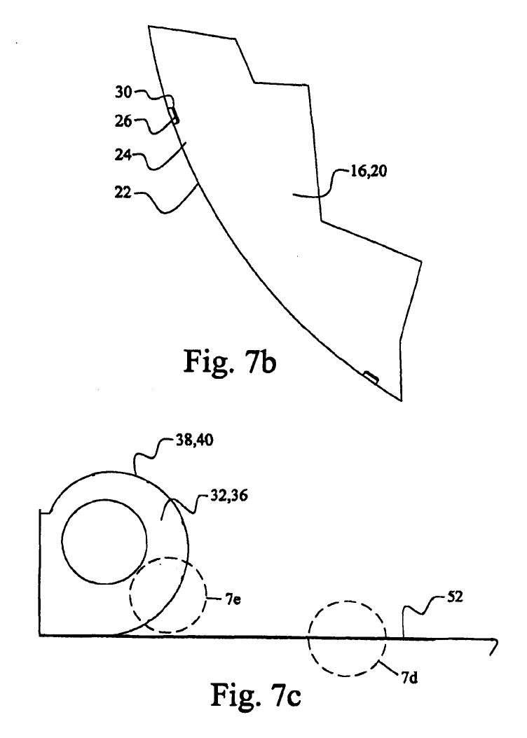

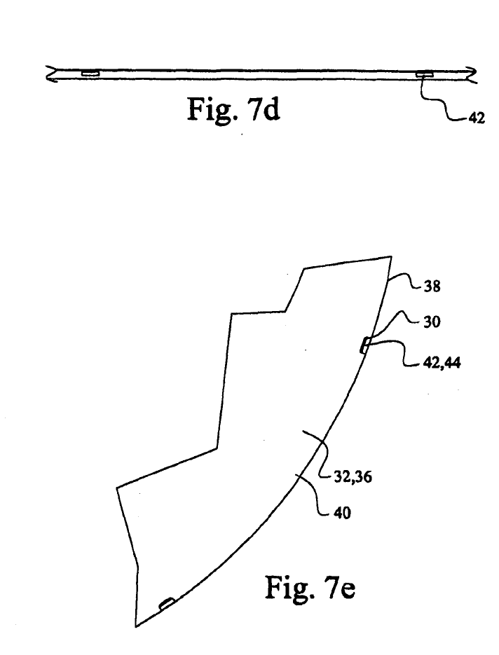

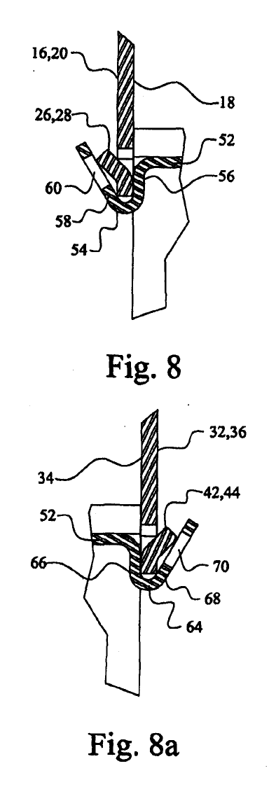

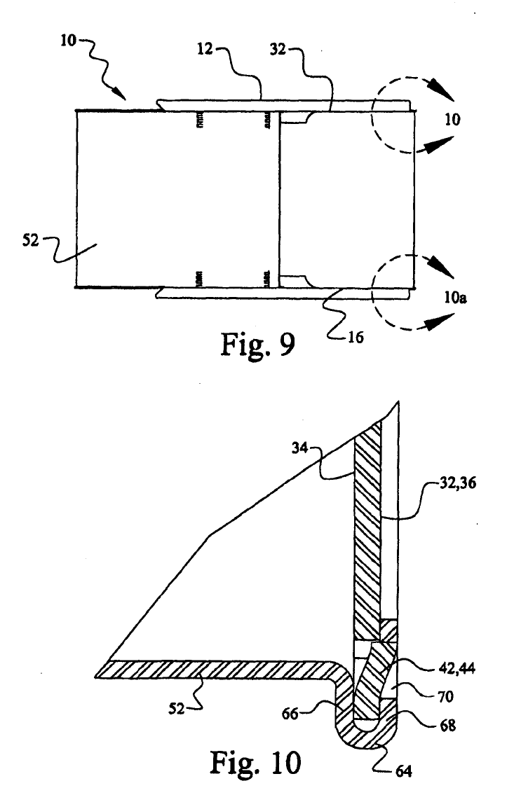

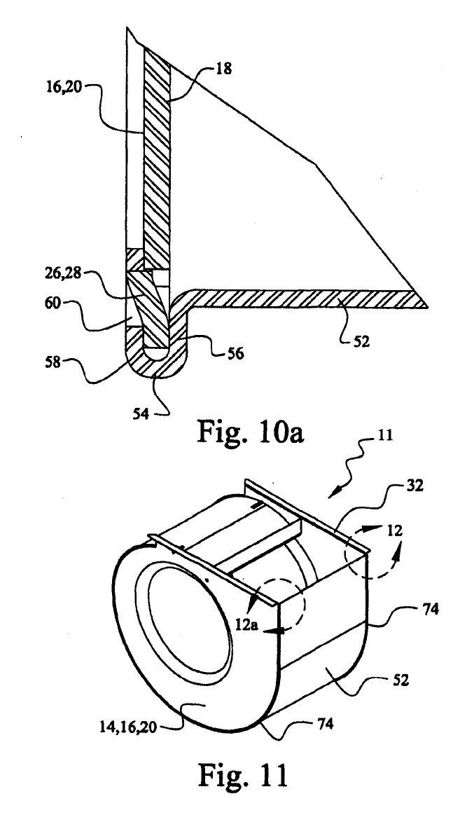

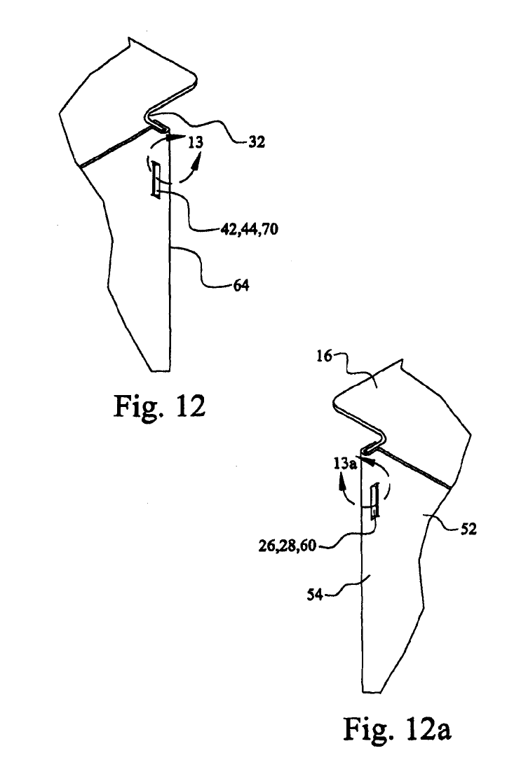

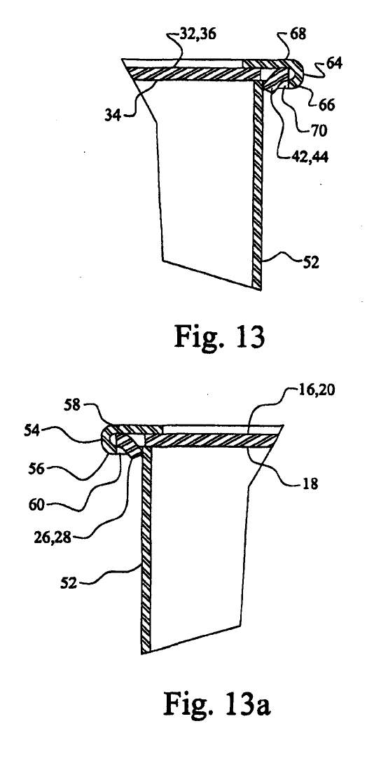

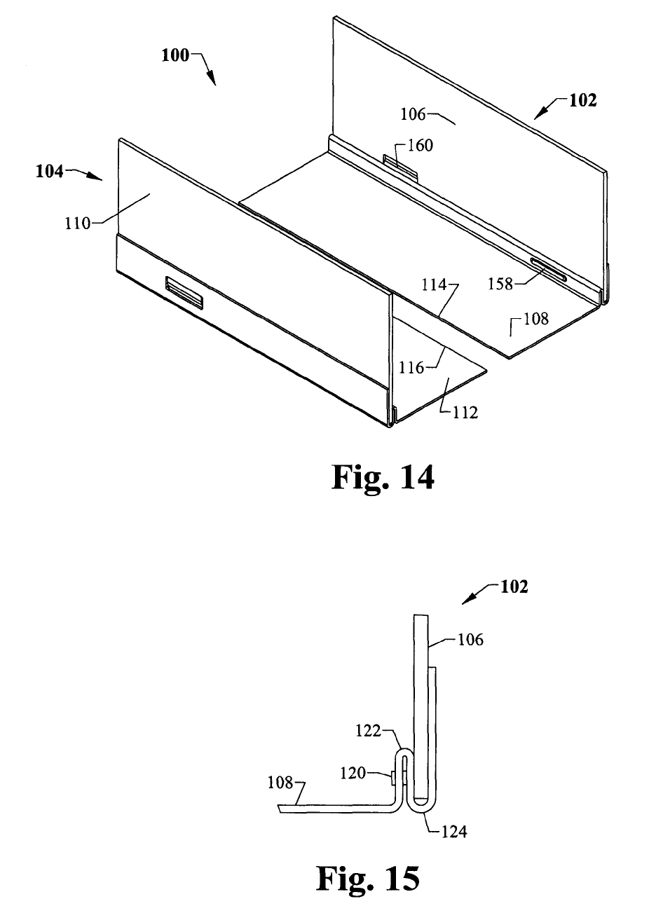

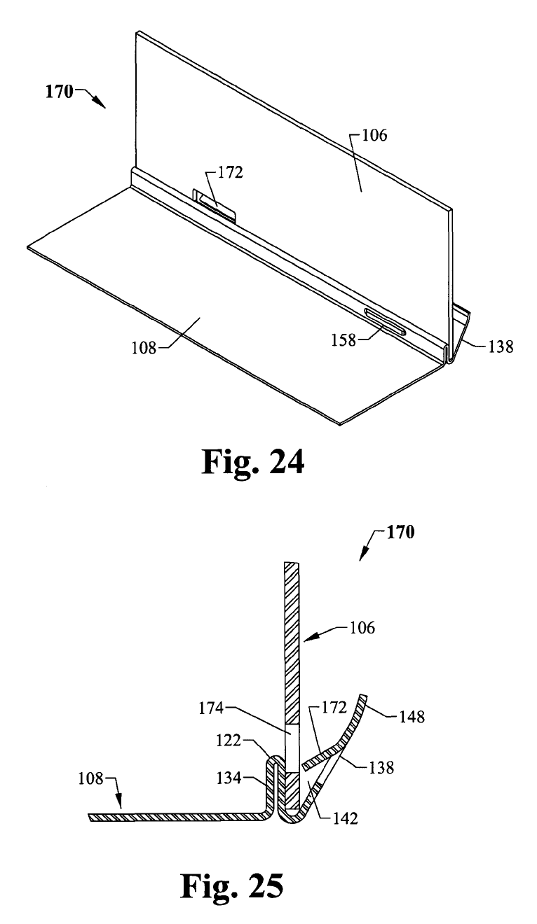

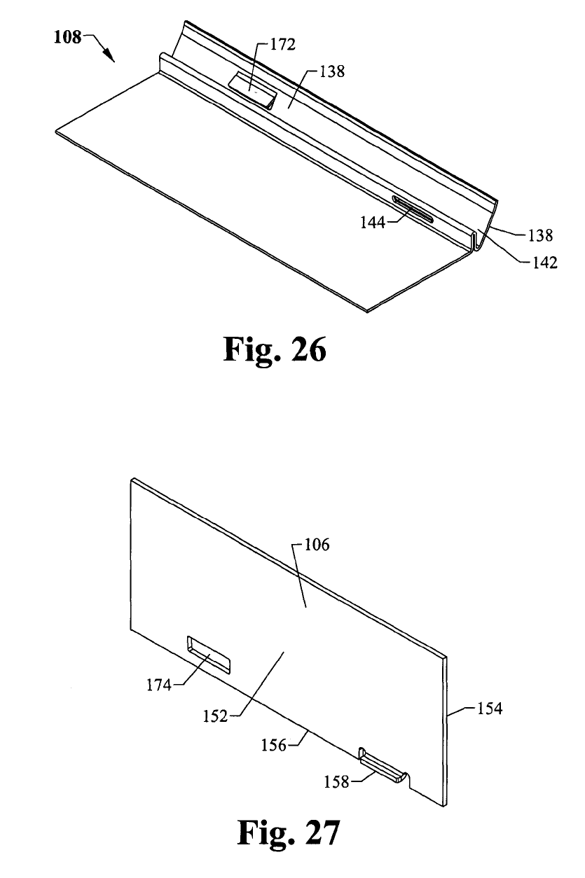

Referring now to the drawings, there is shown in FIGS. 1-10a a first exemplary embodiment of a blower housing 10 and method of manufacture and in FIGS. 11-13a an exemplary alternative embodiment of a blower housing and method of manufacture 11. Various other adaptations, variations and modifications of blower housing and methods of manufacture are shown and described hereinbelow in relation to FIGS. 14-45. Method aspects of the housings are in part explained and in part apparent from the description set forth below.

Referring now to FIGS. 1-10a, the exemplary blower housing 10 comprises a first side wall 16, a second side wall 32 (collectively sidewalls 14) opposite the first side wall 16, and a wrapper wall sheet 52 attached intermediate the first side wall 16 and the second side wall 32.

In the example shown, the wrapper wall sheet 52 includes a first lateral edge flange 54 and a second lateral end flange 64 opposite the first lateral edge flange 54. The first lateral edge flange 54 includes a first inner portion 56 and a first outer portion 58 having one or more first apertures 60 and the opposite second lateral edge flange 64 includes a second inner portion 66 and a second outer portion 68 having one or more second apertures 70. The first side wall 16 has a first inner surface 18, a first outer surface 20, and a first circumferential edge 22 with a first edge margin 24 having one or more first protrusions 26. The opposite second side wall 32 has a second inner surface 34, a second outer surface 36, and a second circumferential edge 38 with a second edge margin 40 having one or more second protrusions 42. The one or more first protrusions 26 protrude from the first outer surface 20 of the first side wall 16 and the one or more second protrusions 42 protrude from the second outer surface 36 of the second side wall 32. The one or more first apertures 60 of the wrapper wall sheet 52 are capable of receiving the one or more first protrusions 26 of the first side wall 16 and the one or more second apertures 70 of the wrapper wall sheet 52 are capable of receiving the one or more second protrusions 42 of the second side wall 32. This allows the first lateral edge flange 54 of the wrapper wall sheet 52 to attach with the first edge margin 24 of the first circumferential edge 22 of the first side wall 16 and the second lateral edge flange 64 of the wrapper wall sheet 52 to attach with the second edge margin 40 of the second circumferential edge 38 of the second side wall 32 by a formed joint or seam 74.

The formed joint or seam 74 includes the combination of the one or more first protrusions 26 of the first edge margin 24 of the first side wall 16 received within the one or more first apertures 60 of the first lateral edge flange 54 of the wrapper wall sheet 52. The one or more second protrusions 42 of the second edge margin 40 of the second side wall 32 are received within the one or more second apertures 70 of the second lateral edge flange 64 of the wrapper wall sheet 52 also to form a joint or seam 74. Thus, when the first lateral edge flange 54 of the wrapper wall sheet 52 is formed or pressed against the first edge margin 24 of the first side wall 16 and the second lateral edge flange 64 of the wrapper wall sheet 52 is formed or pressed against the second edge margin 40 of the second side wall 32, the one or more first protrusions 26 are substantially locked within the one or more first apertures 60 and the one or more second protrusions 42 are substantially locked within the one or more second apertures 70.

In an exemplary embodiment, the one or more first apertures 60 further include one or more first elongated apertures or slots and the one or more second apertures 70 further include one or more second elongated apertures or slots. In a preferred embodiment, the elongated apertures or slots 60, 70 are approximately ⅜ inches long and approximately ⅛ inches wide. In this embodiment, prior to attaching the wrapper wall sheet 52 to the first and second side walls 16, 32, both the first outer portion 58 of the first lateral edge flange 54 of the wrapper wall sheet 52 and the second outer portion 68 of the second lateral edge flange 64 of the wrapper wall sheet 52 are formed at an approximate 30° angle to a vertical axis. Additionally, both the first inner portion 56 of the first lateral edge flange 54 and the second inner portion 66 of the second lateral edge flange 64 are substantially vertical or at an approximate 0° angle relative to the vertical axis. Alternatively, other angles may likewise be utilized that allow the flanges 54, 64 to function as described herein. The size and quantity of the apertures 60, 70 and protrusions 26, 42 forming the locking tab 28, 44 and slot 60, 70 of the seam 74 may be dictated by the size and type of blower housing 11.

The one or more first protrusions 26 may also include one or more first tabs 28 and the one or more second protrusions 26 may include one or more second tabs 44. Both the one or more first tabs 28 and the one or more second tabs 44 may be formed, for example, by punching one or more substantially U-shaped members 30 along both the first and the second edge margins 24, 40 and bending (i.e. bent tab) the one or more substantially U-shaped members 30 outward such that one or more first protrusions 26 or first tabs 28 and the one or more second protrusions 42 or second tabs 44 are formed and protrude from the first outer surface 20 and the second outer surface 36, respectively. In such an embodiment, prior to attaching the wrapper wall sheet 52 to the first and second side walls 16, 32, both the one or more first tabs 28 and the one or more second tabs 44 are formed such that they are protruding outward at an approximate 45° angle from a vertical axis. Alternative embodiments may utilize other angles, however, that likewise allow the tabs 28, 44 to function as described herein.

The one or more first tabs 28 and the one or more second tabs 44 are respectively formed and spaced along the first edge margin 24 and second edge margin 40 such that the one or more first tabs 28 are capable of being received within the one or more first slots 60 and the one or more second tabs 44 are capable of being received within the one or more second slots 70. In the exemplary embodiment, when received, said tabs 28, 44 or protrusions 26, 42 forcibly engage or contact a wall of said slots or apertures 60, 70. That is, if preferred tolerances are maintained when assembled, a portion of the each protrusion 26, 42 contacts a portion of the aperture 60, 70 wall within which it is received or mated.

In an alternative embodiment of the improved blower housing 10, the first lateral edge flange 54 of the wrapper wall sheet 52 may further include a first outer portion 58 and a first inner portion 56 having one or more first apertures 60, and the opposite second lateral edge flange 64 further comprises a second outer portion 68 and a second inner portion 66 having one or more second apertures 70. Also in such an embodiment, the one or more first protrusions 26 may protrude from the first inner surface 18 of the first side wall 16 and the one or more second protrusions 42 may protrude from the second inner surface 34 of the second side wall 32. That is, the location of the apertures 60, 70 are in the inner portion 56, 66 of the wrapper wall sheet 52 flanges 54, 64 and the location of the protrusions 26, 42 are on the inner surfaces 18, 34 of the side walls 14, as opposed to in the outer portion 58, 68 of the flanges 54, 64 and the outer surfaces 20, 36 of the side walls 16, 32 as in the example described above. This locates the combination locking tab 28, 44 and slot 60, 70 of the seam 74 on the first inner surface 18 of the first side wall 14 and the second inner surface 34 of the second side wall 32 of the improved blower housing 10, 11. The tabs 28, 44 and slots 60, 70 are accordingly less visible on the improved blower housing 10, 11 assembly versus the exemplary embodiment where said tabs 28, 44 and slots 60, 70 are located on the outer surfaces 20, 36 of the side walls.

In other alternative embodiments, the first side wall edge 22 may include a first edge margin 24 having one or more first apertures 60 and a second side wall edge 38 including a second edge margin 40 having one or more second apertures 70. The wrapper wall sheet 52 may also include a first lateral edge flange 54 having one or more first protrusions 26 and a second lateral edge flange 64 having one or more second protrusions 42. Both the one or more first protrusions 26 and the one or more second protrusions 42 are capable of formation in either an inner portion 56, 66 or an outer portion 58, 68 of the lateral edge 54, 64 thereby effecting whether the combination locking tab 28, 44 and slot 60, 70 of the seam 74 is located on either an outer portion 58, 68 or outer surface 20, 36 or an inner portion 56, 66 or inner surface 18, 34 as in other embodiments of the improved blower housing 10, 11.

The blower housing 10 may be manufactured by forming and providing a first side wall 16, a second side wall 32 opposite the first side wall 16, and a wrapper wall sheet 52 attached intermediate the first side wall 16 and the second side wall 32. The wrapper wall sheet 52 is first formed, for example, by punching or forming the one or more first apertures 60 along the first lateral edge flange 54 and punching or forming the one or more second apertures 70 along the second lateral edge flange 64. Second, the first lateral edge flange 54 may be bent into a substantially J-shaped first member and the second lateral edge flange 64 may be bent into a substantially J-shaped second member such that the substantially J-shaped first member has the first inner portion 56 and the first outer portion 58 and the substantially J-shaped second member has the second inner portion 66 and the second outer portion 68. Both of the one or more first apertures 60 are punched on the first lateral edge flange 54 and the one or more second apertures 70 are punched on the second lateral edge flange 64 and positioned such that they are within the first outer portion 58 and the second outer portion 68, respectively. Alternative embodiments may utilize methods such as laser, water jet, or torch cutting to form said apertures 60, 70 in lieu of punching.

The first and second side walls 14, 32 may be formed, for example, by forming and punching one or more substantially U-shaped members 30 along both the first and the second edge margins 24, 40 and bending the one or more substantially U-shaped members 30 outward such that the one or more first protrusions 26 or first tabs 28 and the one or more second protrusions 42 or second tabs 44 are formed and protruding from the first outer surface 20 and the second outer surface 36, respectively.

The wrapper wall sheet 52 is then positioned and held intermediate the first side wall 16 and the opposite second side wall 32 such that the one or more first protrusions 26 of the first edge margin 24 of the first side wall 16 are received within the one or more first apertures 60 of the first lateral edge flange 54 of the wrapper wall sheet 52 and the one or more second protrusions 42 of the second edge margin 40 of the second side wall 32 are received within the one or more second apertures 70 of the second lateral edge flange 64 of the wrapper wall sheet 52. The first lateral edge flange 54 of the wrapper wall sheet 52 is then formed or pressed against the first edge margin 24 of the first side wall 16 and the second lateral edge flange 64 of the wrapper wall sheet 52 is formed or pressed against the second edge margin 40 of the second side wall 32. Typically, right and left forming rollers adapted to engage with the flange 54, 64 rotationally press the outer portion 58, 68 onto and with said edge margin 24, 40. Other methods understood within the art may be utilized to perform the aforesaid pressing operation.

After forming both the first lateral edge flange 54 and the second lateral edge flange 64, the one or more first protrusions 26 are substantially locked within the one or more first apertures 60, and the one or more second protrusions 42 are substantially locked within the one or more second apertures 70 and essentially non-separable. The substantial lockup provides three-axial locking thereby providing greater stability and minimal slippage in a forming machine. That is, the wrapper wall sheet 52 is substantially locked to the first side wall 16 and the second side wall 32 after just starting to form the first and second lateral edges 54, 64 with only one first protrusion 26 received within one first aperture 60 and/or one second protrusion 42 received within one second aperture 70.

Within the aforesaid first alternative embodiments, the wrapper wall sheet 52 has both the one or more first apertures 60 punched on the first lateral edge flange 54, the one or more second apertures 70 punched on the second lateral edge flange 64, and each are positioned such that they are within the first inner portion 56 and the second inner portion 66, respectively. The first and second side walls 16, 32 are preferably formed by punching one or more substantially U-shaped members 30 along both the first and the second edge margins 24, 40, bending the one or more substantially U-shaped members 30 inward such that one or more first protrusions 26 or first tabs 28 and the one or more second protrusions 42 or second tabs 44 are formed and protruding from the first inner surface 18 and the second inner surface 34 respectively. Further alternate embodiments may utilize protrusions 26, 42 which are simply drawn from or which are attached with the edge margins 24, 40. Assembly may proceed as described above.

Within another alternative embodiment, the wrapper wall sheet 52 may be formed by forming or punching one or more substantially U-shaped members 30 along both the first and the second lateral edge flanges 54, 64 and bending both the one or more substantially U-shaped members 30 outward such that one or more first protrusions 26 or tabs 28 and the one or more second protrusions 42 or tabs 44 are formed and protrude from the first outer portion 58 and the second outer portion 68, respectively. The first and second side walls 16, 32 are preferably formed by forming or punching one or more first apertures 60 along the first edge margin 24 and punching one or more second apertures 70 along the second edge margin 40. The wrapper wall sheet 52 is positioned and held intermediate the first side wall 16 and the opposite second side 32 wall such that the one or more first protrusions 26 of the first lateral edge 54 are received within the one or more first apertures 60 of the first edge margin 24 of the first side wall 16 and the one or more second protrusions 42 of the second lateral edge 64 are received within the one or more second apertures 70 of the second edge margin 40 of the second side wall 32. The first lateral edge 54 of the wrapper wall sheet 52 is formed or pressed against the first edge margin 24 of the first side wall 16 and the second lateral edge 64 of the wrapper wall sheet 52 is formed or pressed against the second edge margin 40 of the second side wall 32. Again, typically right and left forming rollers adapted to engage with the flange 54, 64 rotationally press the outer portion 58, 68 onto and with said edge margin 24, 40. After forming both the first lateral edge 54 and the second lateral edge 64, the one or more first protrusions 26 are substantially locked within the one or more first apertures 60, and the one or more second protrusions 42 are substantially locked within the one or more second apertures 70 and are essentially non-separable.

Further alternative embodiments encompass the one or more substantially U-shaped members 30 along both the first and the second lateral edge flanges 54, 64. The members 30 may be bent inward such that the one or more first tabs 28 and the one or more second tabs 44 are formed and protruding from the first inner portion 56 and the second inner portion 66, respectively. Again, assembly may proceed as described above.

From the foregoing description, those skilled in the art will appreciate that the blower housing and method of manufacture 10 has been shown and described. The resultant housing assembly is easy and cost effective to manufacture and repair, and further provides positive blower housing 12 component 14, 52 locking without slippage and without the use of spot welds or other types of fasteners.

Various other adaptations of the assemblies and methods described above are possible, including but not limited to those described below.

FIG. 14 is a perspective assembly view of another blower housing assembly 100 formed in accordance with an exemplary embodiment of the invention. The assembly 100 generally includes two mirror-image subassemblies 102 and 104. That is, the subassemblies 102, 104 may be substantially identically constructed to one another, but reversed 180° and arranged to face one another in a box-like configuration that unlike the previous embodiments do not involve a curved, circumferential wall. The subassembly 102 includes a side wall sheet 106 and a wrapper wall sheet 108. The subassembly 104 also includes a side wall sheet 110 and a wrapper wall sheet 112. The side wall sheets 102 and/or 104 may be load bearing walls, and accordingly may each have a different thickness. The wrapper wall sheets 108, 112 may also have a different thickness depending on particular requirements for the assembly 100 when installed. Alternatively, the wrapper wall sheets 108, 112 may have the same thickness and the side wall sheets 106, 110 may have the same thickness equal to or different from the thickness of the wrapper wall sheets 108, 112.

The side wall sheets 102 and 104 are spaced apart from one another in a generally parallel manner, and the wrapper wall sheets 108 and 112 extend inwardly from the side walls 102, 104 toward one another. Distal ends 114, 116 of the respective wrapper wall sheets 108, 112 are shown spaced apart in FIG. 14, and could be directly abutted or otherwise joined or connected to one another using known techniques, or indirectly joined to one another via another component (not shown) spanning the gap between the ends 114, 116. It is contemplated, however, that in other embodiments one wrapper wall sheet extending the entire distance between the side walls 102 and 104 could alternatively be used in lieu of two separately provided wrapper wall sheets 108 and 112 as shown.

FIG. 15 is an end view of a portion of the blower housing subassembly 102 illustrating the side wall 106 and the wrapper wall sheet 108 joined to one another and defining a seam. The side wall includes a protrusion 120 extending through corresponding openings in the wrapper wall sheet 108 to interlock the side wall 106 to the wrapper wall sheet 108. The wrapper wall sheet 108 is formed into an S-shape including two 180° bends 122, 124 proximate the side wall 106 for additional locking capability.

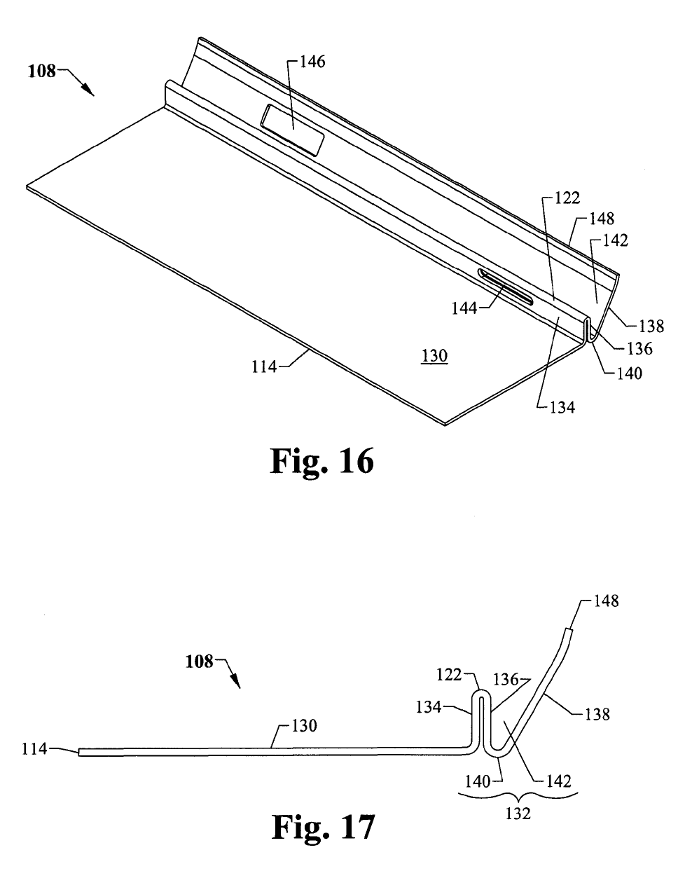

FIGS. 16 and 17 are a perspective view and end view of the wrapper wall sheet 108 at a first stage of manufacture prior to assembly with the side wall 106. The wrapper wall sheet 108 includes a generally flat and planar region 130 including the distal end 114, and a formed lateral edge flange 132 extending opposite the distal end 114. In the example shown, the lateral edge flange 132 includes generally parallel upstanding wall portions 134, 136 extending generally perpendicularly to the plane of the flat region 130 and interconnected by the first 180° bend 122. An edge portion 138 extends from a lower end of the upstanding wall portion 136 at an oblique angle to the upstanding wall portions 134, 136 and the flat region 130. That is, at this stage of manufacture a bend 140 of more than 180° extends between the lower end of the upstanding wall portion 136 and the edge portion 138. The wall portion 136 and the edge portion 138 define a channel 142 therebetween that receives the side wall 106 (FIGS. 14 and 15) during assembly.

As best seen in FIG. 16, the lateral edge flange 132 includes elongated openings or apertures 144 and 146. The opening 144 extends through each of the upstanding wall portions 134 and 136, and the opening 146 extends through the edge portion 138. As such, openings 144 and 146 are provided in each side of the channel 142 that receives the side wall 106. While two openings 144 and 146 are shown in this example, it is recognized that additional openings may be provided as desired. Also, as shown in FIGS. 16 and 17, the edge portion 138 may include 132 may further include an angled lip 148 at its outer extremity that reduces an angle of inclination of the extremity with respect to the upstanding side walls 134, 136.

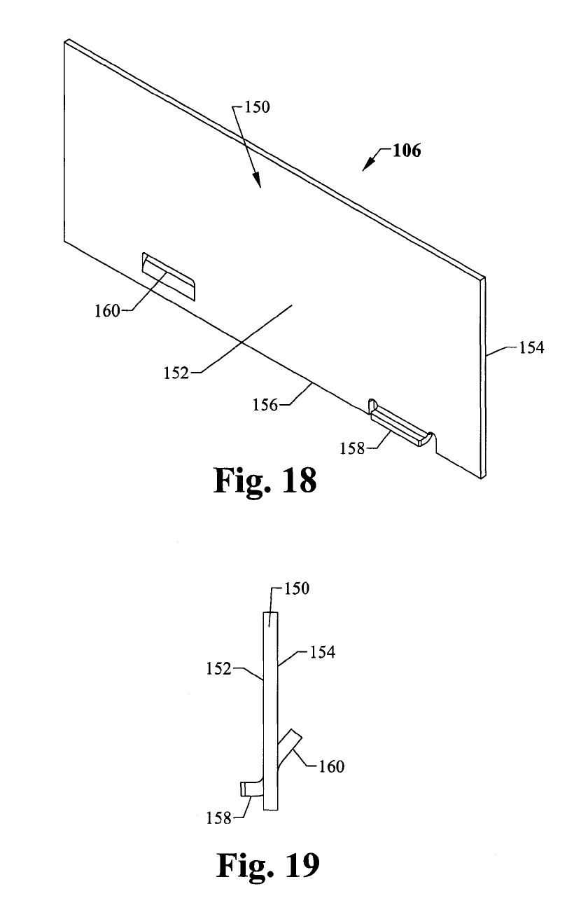

FIGS. 18 and 19 are a perspective view and end view of the side wall 106 at a stage of manufacture prior to assembly with the wrapper wall sheet 108 (FIGS. 16 and 17). In the example shown, the side wall 106 includes a generally flat and planar region 150 having a first major surface 152 and a second major surface 154 extending in an opposed relationship to one another. The side wall 150 also includes an edge margin 156 having a first protrusion 158 extending outwardly from the first major surface 152 and a second protrusion 160 extending outwardly from the second major surface 154. While two protrusions are shown, it is understood that additional protrusions may be provided as desired.

Each of the protrusions 158, 160 may be formed as U-shaped tabs, for example, bent in a manner to project from the major surfaces 158, 160. Also, in the example shown, the protrusion 158 is formed to extend generally perpendicularly to the plane of the flat region 150, while the protrusion 160 is formed to extend obliquely from the flat region 150 on the opposing sides thereof.

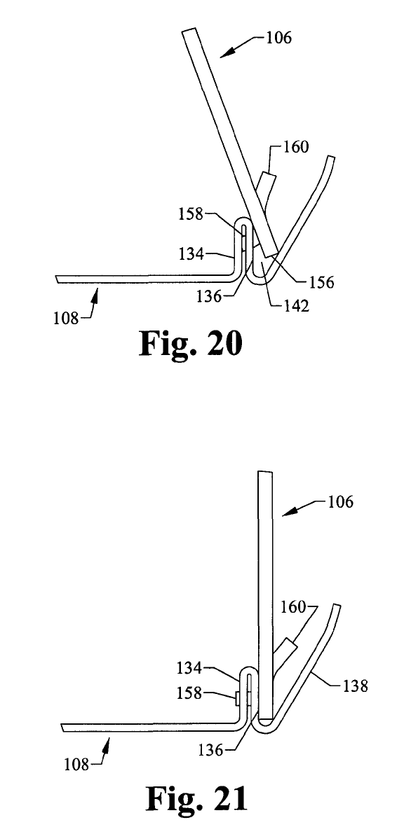

FIG. 20 illustrates an assembly of the side wall 106 and the wrapper wall sheet 108. The edge margin 156 of the side wall 106 is extended into the channel 142 in the wrapper wall sheet 108 and the protrusion 158 is being inserted through the openings 144 (FIG. 16) in wrapper wall members 134, 136. FIG. 21 illustrates the protrusion 158 in an engaged, but unlocked position extending through the wrapper wall members 134, 136. When so positioned, the edge portion 138 of the wrapper wall sheet 108 may be pressed and formed against the side wall 106 to lock the protrusions 158 to the openings 144. As the edge portion 138 is pressed, the protrusion 160 is also received in the opening 146 (FIG. 16) in the lateral edge flange 132 of the wrapper wall sheet 108, therefore completing the subassembly 102 as shown in FIG. 14. As previously mentioned, the subassembly 104 shown in FIG. 14 may be completed in a substantially similar manner to the subassembly 102.

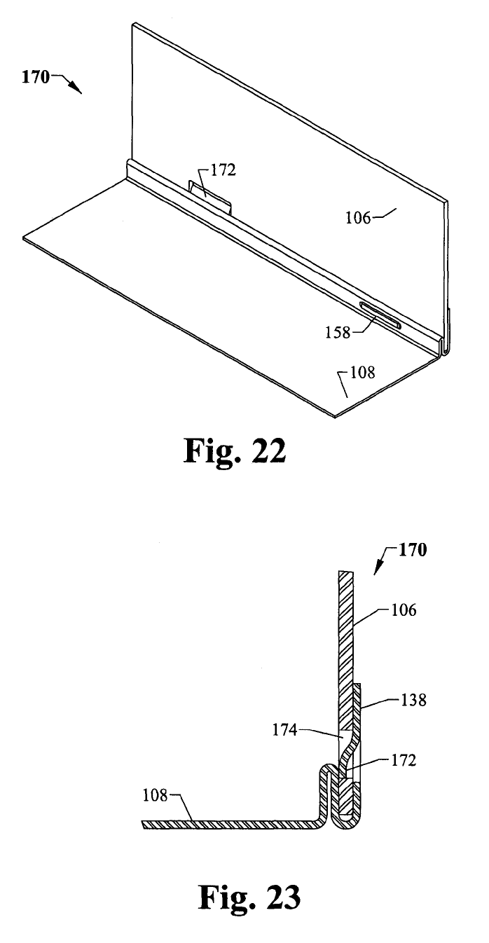

FIGS. 22-27 illustrate various views of another exemplary subassembly 170 that may be used in lieu of the subassembly 102 described above. For the sake of brevity, like reference characters will be used to indicate like features between the subassemblies 102 and 160 in FIGS. 14-21 and FIGS. 22-27.

Unlike the assembly 102, the lateral end flange of the wrapper wall sheet 108 in the assembly 170 includes, in addition to the opening 144 in the upstanding wall members 134 and 136, a protrusion 172 formed in the edge portion 138. The protrusion 172 extends into the channel 142 toward the side wall 106 when assembled as shown in FIG. 23-25. While one opening and one protrusion is shown in the wrapper wall sheet in this example, it is recognized that additional protrusions and openings may be provided in further embodiments as desired.

The side wall 106 as best seen in FIG. 27 includes, in addition to the protrusion 158, an elongated opening 174 that mates with the protrusion 172 in the wrapper wall sheet 108. By providing an opening and a protrusion in each respective one of the wrapper wall sheet 108 and the side wall 106 additional degrees of locking effectiveness may be achieved. While one opening and one protrusion is shown in the side wall in this example, it is recognized that additional protrusions and openings may be provided in further embodiments as desired.

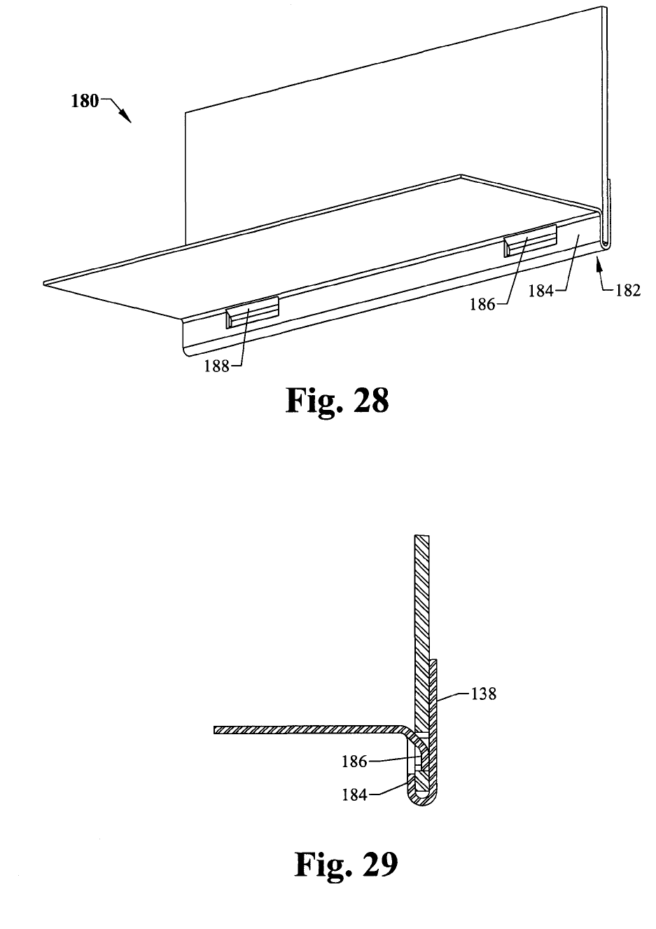

FIGS. 28-33 illustrate various views of still another exemplary housing subassembly 180 that may be used in lieu of the subassemblies 102 and 160 described above. For the sake of brevity, like reference characters will be used to indicate like features in FIGS. 28-33.

The subassembly 180 includes a wrapper wall sheet 108 with a lateral edge flange 182 defining a channel 142 without the double-walled arrangement utilizing wall members 134, 136 in the embodiments described above. That is, the lateral edge flange 182 includes a single wall member 184 extending generally perpendicularly from the flat region 130 of the wrapper wall sheet 108. Additionally, and as seen in FIGS. 28-33, the wall member 184 extends downwardly rather than upwardly.

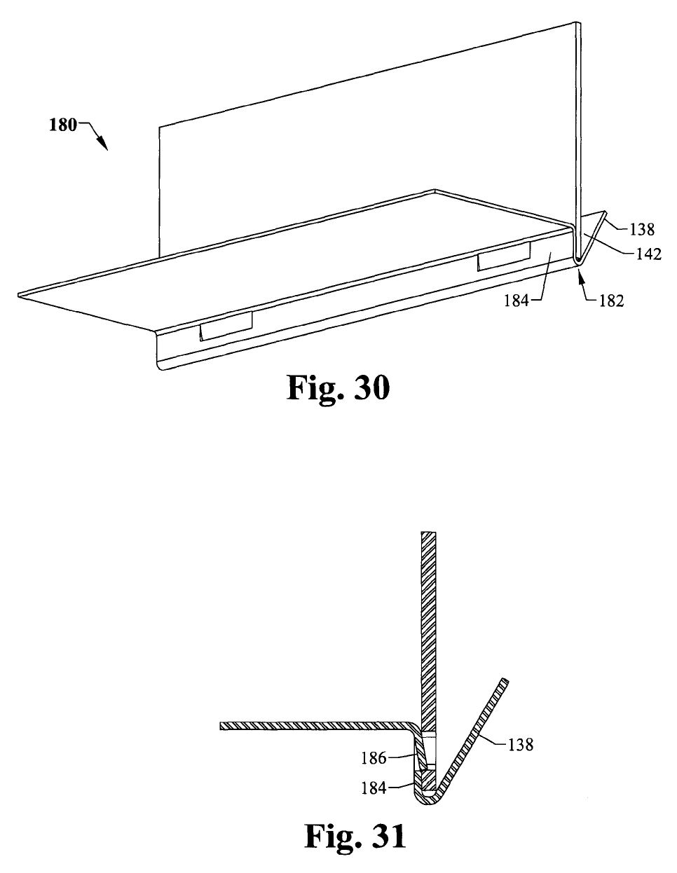

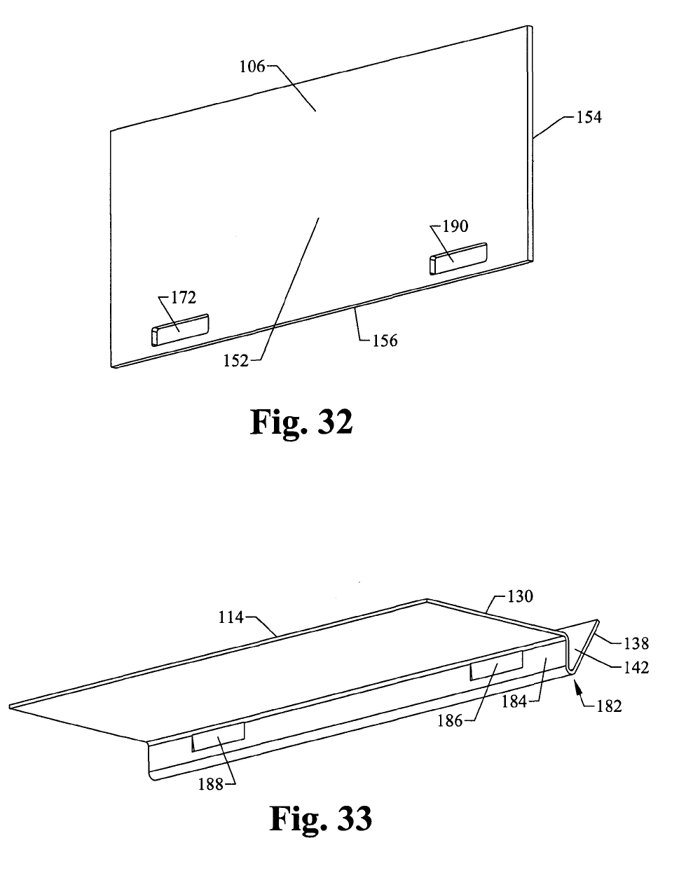

Protrusions 186 and 188 are formed in the single wall member 184 and extend into the channel 142 in the example shown. As best shown in FIG. 32, the side wall includes openings 172 and 190 at the edge margin 156. Unlike the subassemblies 102 and 160, the side wall 106 in this embodiment does not include any protrusions. When the wrapper wall sheet 108 is assembled with the side wall 106 with the wrapper wall protrusions 186, 188 extending through the respective side wall openings 172 and 190 as shown in FIGS. 30 and 31, the wrapper wall edge portion 138 may be formed against the side wall to interlock the protrusions and apertures and form a housing seam as shown in FIGS. 28 and 29. While two openings are shown in the side wall in this example cooperating with two protrusions in the wrapper wall sheet, it is recognized that additional protrusions and openings may be provided in the respective side wall and wrapper wall sheet in further embodiments as desired.

While the straight edge seams described above in relation to FIGS. 14-33 may be beneficial in some applications, it is contemplated that the wrapper wall sheet and side wall construction and methodology described above in relation to FIGS. 14-33 could be utilized with curved or circumferential wrapper wall sheets similar to those described above in relation to FIGS. 1-13. Likewise, it is contemplated that the construction and methodology described in relation to FIGS. 1-13 could be applied to form straight edge seams in lieu of curved, circumferential seams.

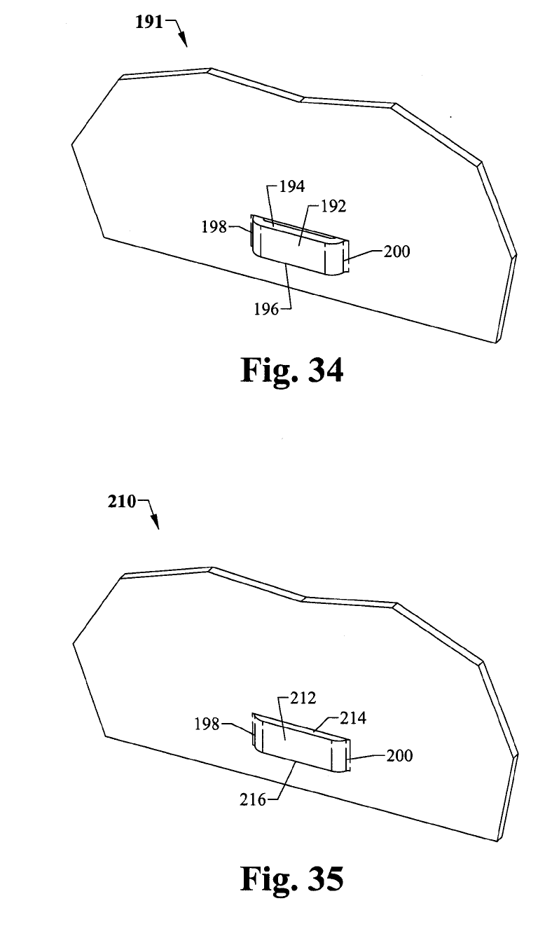

FIG. 34 shows an exemplary blower housing side wall sheet section 191 showing a protrusion 192 that is cut through the thickness of the side wall on the opposing top edge 194 and bottom edge 196, while remaining fully attached at the opposing side edges 198 and 200. Punching or stamping processes may be utilized, for example, to form the protrusion 192 to extend in a generally planar fashion but being offset or spaced from the plane of the side wall section 191. Such a protrusion 192 may be an appealing alternative to the U-shaped tab protrusions discussed above, and when mated with complementary openings may be effectively utilized to create interlocking seams with wrapper wall sheets.

FIG. 35 shows an exemplary blower housing side wall sheet section 210 showing a protrusion 212 that is cut partway through on the top and bottom edges 214 and 216. That is, unlike the protrusion 192 discussed above, the protrusion does not involve cuts made entirely through the thickness of the side wall 210. Rather, the top and bottom edges 214 and 216 are incompletely cut so as to weaken the material and facilitate formation of the protrusion 212, without separating the protrusion from the side wall 210 at the top and bottom edges. Like the protrusion 192, the protrusion 212 is fully attached at the opposing side edges 198 and 200. That is, the side edges 198. 200 are not cut at all. Such a protrusion 212 may be an appealing alternative to the protrusion 192 discussed above in certain embodiments, and when mated with complementary openings may be effectively utilized to create interlocking seams with wrapper wall sheets.

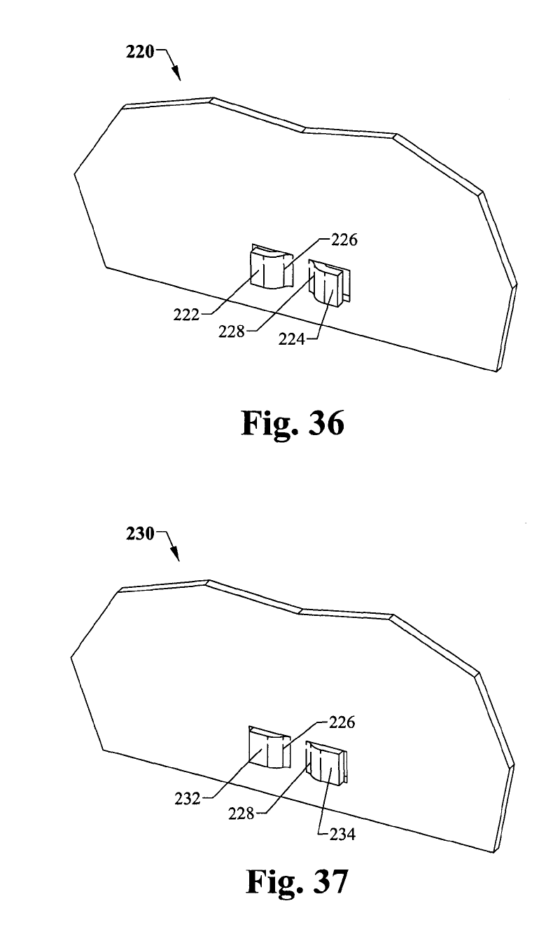

FIG. 36 shows an exemplary blower housing side wall sheet section 220 showing protrusions 222, 224 that are cut through the thickness of the side wall on three sides thereof 226, 228 while the facing sides remain uncut. The protrusions 222, 224 may extend in opposite directions as shown, or alternatively may extend in a common direction if desired. The protrusions 222, 224 may be appealing alternatives to the protrusions discussed above in certain embodiments, and when mated with complementary openings may be effectively utilized to create interlocking seams with wrapper wall sheets.

FIG. 37 shows an exemplary blower housing side wall sheet section 230 showing protrusions 232, 234 that are cut partway through on three sides while the facing sides 226, 228 remain uncut. That is, edges of the protrusions 232, 234 apart from the facing sides 226, 228 are incompletely cut through the thickness of the side wall cut so as to weaken the material and facilitate formation of the protrusions 232 and 234, without separating any portion of the protrusions from the side wall 230. The protrusions 232, 234 may extend in opposite directions as shown, or alternatively may extend in a common direction if desired. The protrusions 232, 234 may be appealing alternatives to the protrusions discussed above in certain embodiments, and when mated with complementary openings may be effectively utilized to create interlocking seams with wrapper wall sheets.

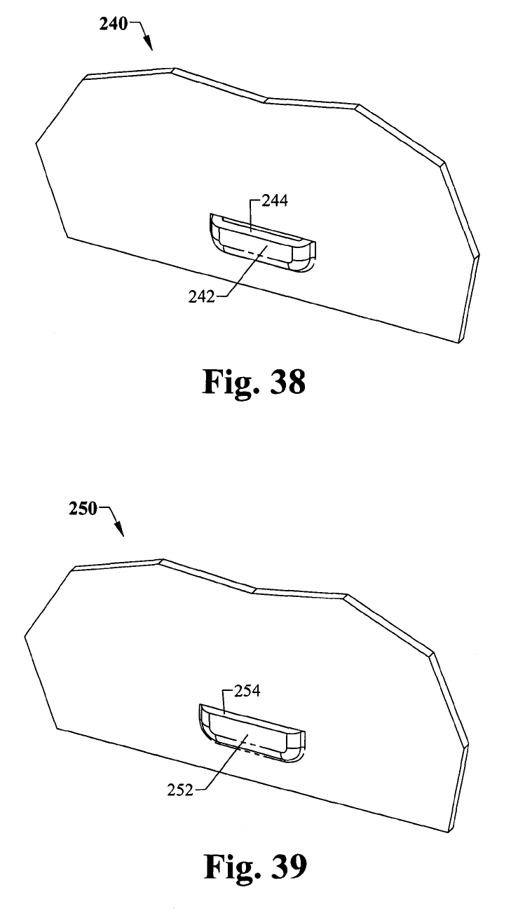

FIG. 38 is a blower housing side wall sheet section 240 showing a protrusion 242 that is cut completely through a thickness of the side wall 240 on one side 244 while the other three sides remain uncut. That is, the side edges of the protrusion 242 apart from the side 244 are incompletely cut through the thickness of the side wall cut so as to weaken the material and facilitate formation of the protrusion 242 but without separating those edges from the side wall 240. The protrusion 242 may be an appealing alternatives to the protrusions discussed above in certain embodiments, and when mated with complementary openings may be effectively utilized to create interlocking seams with wrapper wall sheets.

FIG. 39 is a blower housing side wall sheet section 250 showing a protrusion 252 that is cut partway through on one side 254 while the other three sides remain uncut. The protrusion 252 may be an appealing alternatives to the protrusions discussed above in certain embodiments, and when mated with complementary openings may be effectively utilized to create interlocking seams with wrapper wall sheets.

Any of the above described protrusions may be mixed and matched in still further embodiments. That is, more than one of the different types of protrusions may be utilized on any given side wall section in combination to provide interlocking housing seams.

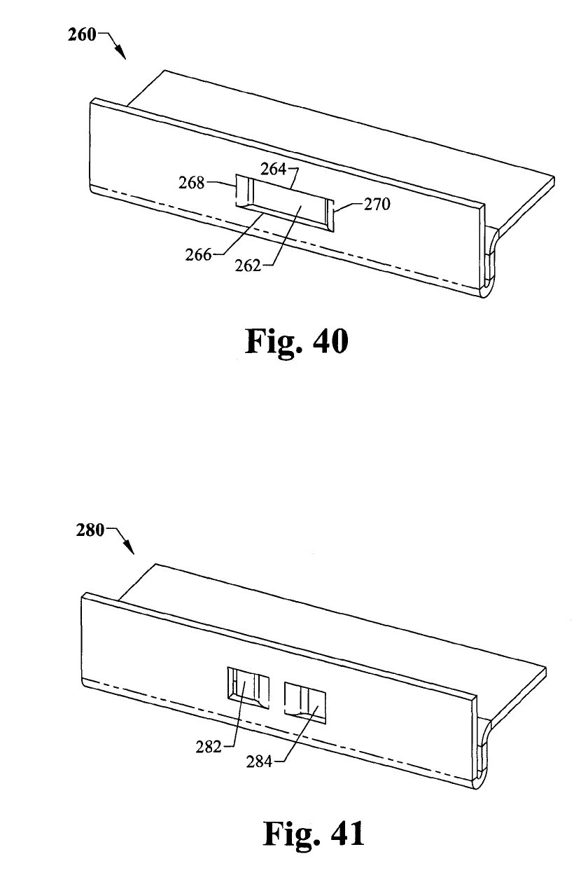

As FIGS. 40-45 show, such protrusions may also be formed in the wrapper wall sheet sections.

FIG. 40 shows an exemplary wrapper wall sheet section 260 showing a protrusion 262 that is cut through on opposing side edges 264, 266 while the side edges remain uncut. 268, 270 remain uncut. The protrusion 262 is therefore similar to the protrusion 192 (FIG. 34) described above. The protrusion 262 faces the side wall when assembled with a side wall as described above.

FIG. 41 is wrapper wall sheet section 280 showing protrusions 282, 284 that are cut partway through on three sides while the facing sides remain uncut, and thus are similar to the protrusions 222, 224 shown in FIG. 36. The protrusions 282, 284 face the side wall when assembled with a side wall as described above.

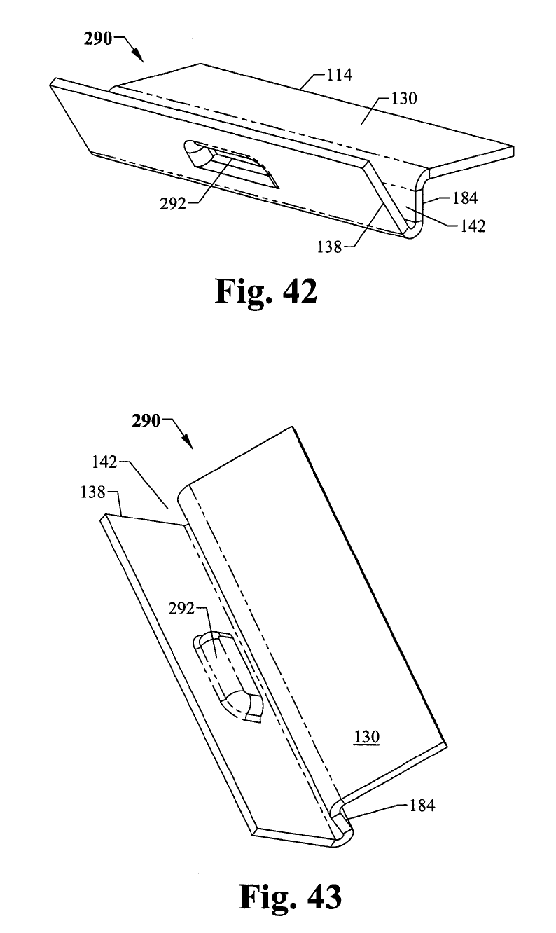

FIGS. 42 and 43 are different views of a blower housing wrapper section 290 showing a protrusion 292 before the end portion 138 is formed against a blower side wall as described above. The protrusion 292 is cut on one side while the other three sides remain uncut and is therefore similar to the protrusion 242 shown in FIG. 38. The protrusion 292 extends into the channel 142 in the wrapper wall sheet 108 and faces the side wall when assembled as described above.

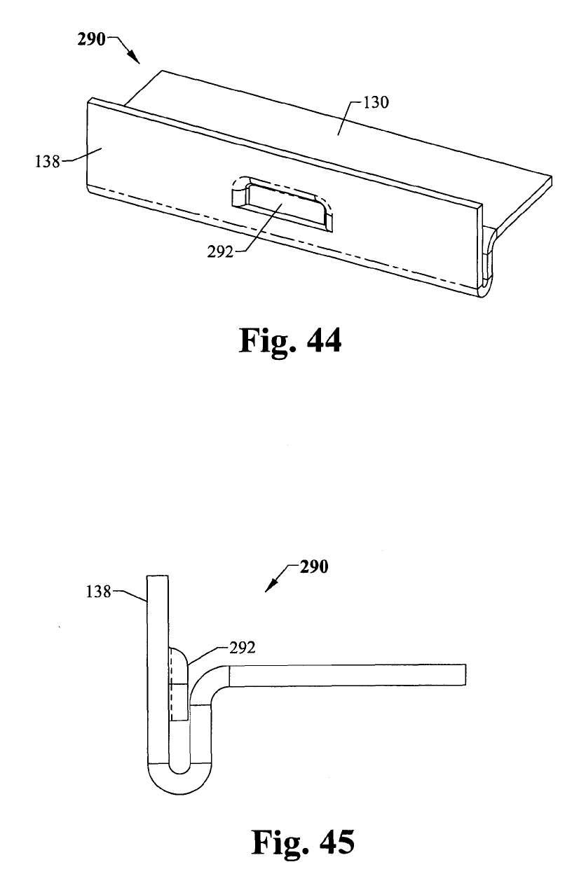

FIGS. 44 and 45 illustrate the wrapper wall sheet section 290 in final form without the side wall shown. When the protrusion 292 is receiving in an opening in the side wall, the wrapper wall sheet and the side walls are effectively locked to one another.

The benefits and advantages of the blower housing structure and methodology described above are numerous and include at least the following.

Positive locking of blower side walls and a wrapper wall sheet or sheets facilitates efficient, effective, and relatively low cost housings from a manufacturing perspective. Welds or fasteners to join the side walls and the wrapper wall sheets are not required, and costs and assembly steps associated with them may accordingly be eliminated.

The housing structures and methodology are environmentally friendly. The wrapper wall sheets and side walls may be rather easily separated and re-used as desired. Especially compared to welded housings that are generally not re-usable, considerable reduction of scrap materials is possible.

The housing structures and methodology is versatile and capable to accommodate wrapper wall sheets and side walls fabricated from different materials and materials of different thicknesses.

The housing structures and relatively easy and economical methodology allows a variety of blower housings of varying size to be fabricated with the same assembly machines. Expensive and time consuming retooling may largely be avoided to manufacture different blower housings.

The housing structures and methodology using the locking protrusions and mating openings provide substantially smooth seams wherein the protrusions are substantially flush with outer surfaces of the blower housing regardless of orientation or material variations.

The benefits and advantages of the invention are now believed to be apparent from the embodiments disclosed.

An embodiment of a blower housing is disclosed including a side wall having an edge margin, and a wrapper wall sheet having a lateral edge flange. One of the edge margin and the lateral edge flange includes at least one protrusion, and the other of the edge margin and the lateral edge flange includes at least one opening. The lateral edge flange of the wrapper wall sheet is attached to the edge margin of the side wall by the at least one protrusion being received and locked within the at least one opening, thereby completing a seam and forming a portion of a blower housing.

Optionally, the at least one protrusion may be defined by a bent tab. The wrapper wall sheet may define a circumferential wall on the blower housing. In various embodiments, the edge margin may include at least one opening and at least one protrusion, the edge margin may include multiple protrusions, or the edge margin includes multiple openings. The side wall may include a first major surface and a second major surface, and a protrusion may extend from each of the first major surface and the second major surface in the edge margin.

As further options, the lateral edge flange may define a channel receiving the edge margin. At least one protrusion may extend into the channel. At least opening may further be provided. The lateral edge flange may include a first opening in a first side of the channel and a second opening in a second side of the channel. The lateral edge flange may further include a first 180° bend. A second 180° bend may optionally be positioned opposite to the first 180° bend.

The seam may be formed without utilizing welding or auxiliary fasteners. The side wall and the wrapper wall sheet may have a different thickness. The side wall and the wrapper wall sheet may be fabricated from different materials.

An exemplary method of manufacturing a blower housing having a side wall and a wrapper wall sheet is also disclosed. The method includes: forming at least one of an aperture and a protrusion within an edge margin of the first side wall; forming at least one of an aperture and a protrusion along a lateral edge flange of the wrapper wall sheet; engaging one or more of the protrusions with corresponding ones of the apertures along the lateral edge flange and the edge margin; and pressing the lateral edge flange against the first edge margin, thereby interlocking one or more of the protrusions with one or more of the apertures along the first lateral edge flange, thereby forming a portion of a blower housing.

Optionally, the method may further include curving the wrapper wall sheet around the edge margin to form a circumferential wall. Forming at least one of an aperture and a protrusion may include forming U-shaped tabs. Forming at least one of an aperture and a protrusion may include forming elongated slots.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blower housing comprising:
a side wall having an edge margin; and
a wrapper wall sheet having a lateral edge flange;
wherein one of the edge margin and the lateral edge flange includes at least one protrusion;
wherein the other of the edge margin and the lateral edge flange includes at least one opening; and
wherein the lateral edge flange of the wrapper wall sheet is attached to the edge margin of the side wall by the at least one protrusion being received and locked within the at least one opening, thereby completing a seam and forming a portion of a blower housing.

2. The blower housing of claim 1, wherein the at least one protrusion is defined by a bent tab.

3. The blower housing of claim 1, wherein the wrapper wall sheet defines a circumferential wall on the blower housing.

4. The blower housing of claim 1, wherein the edge margin includes at least one opening and at least one protrusion.

5. The blower housing of claim 1, wherein the edge margin includes multiple protrusions.

6. The blower housing of claim 1, wherein the edge margin includes multiple openings.

7. The blower housing of claim 1 wherein the side wall includes a first major surface and a second major surface, and a protrusion extends from each of the first major surface and the second major surface in the edge margin.

8. The blower housing of claim 1, wherein the lateral edge flange defines a channel receiving the edge margin.

9. The blower housing of claim 8, wherein the lateral edge flange includes at least one protrusion extending into the channel.

10. The blower housing of claim 8, wherein the lateral edge flange includes at least opening.

11. The blower housing of claim 10, wherein the lateral edge flange includes a first opening in a first side of the channel and a second opening in a second side of the channel.

12. The blower housing of claim 8, wherein the lateral edge flange includes a first 180° bend.

13. The blower housing of claim 12, wherein the lateral edge flange includes a second 180° bend positioned opposite to the first 180° bend.

14. The blower housing of claim 1, wherein the seam is formed without utilizing welding or auxiliary fasteners.

15. The blower housing of claim 1, wherein the side wall and the wrapper wall sheet have a different thickness.

16. The blower housing of claim 1, wherein the side wall and the wrapper wall sheet are fabricated from different materials.

17. A method of manufacturing a blower housing having a side wall and a wrapper wall sheet, the method comprising:
forming at least one of an aperture and a protrusion within an edge margin of the first side wall;
forming at least one of an aperture and a protrusion along a lateral edge flange of the wrapper wall sheet;
engaging one or more of the protrusions with corresponding ones of the apertures along the lateral edge flange and the edge margin; and
pressing the lateral edge flange against the first edge margin, thereby interlocking one or more of the protrusions with one or more of the apertures along the first lateral edge flange, thereby forming a portion of a blower housing.

18. The method of claim 17, further comprising curving the wrapper wall sheet around the edge margin to form a circumferential wall.

19. The method of claim 17, wherein forming at least one of an aperture and a protrusion comprises forming U-shaped tabs.

20. The method of claim 17, wherein forming at least one of an aperture and a protrusion comprises forming elongated slots.
